(19) United States
(12) Patent Application Publication
(10) Pub. No.: US 2013/0222758 A1
(43) Pub. Date: Aug. 29, 2013

(54) GLASSES HAVING LIGHT-EMITTING DIODE ILLUMINATION

(71) Applicants: CHAOFU KELVIN HE, Macau (CN); STEPHEN CHEUNG, Bayside, NY (US)

(72) Inventors: CHAOFU KELVIN HE, Macau (CN); STEPHEN CHEUNG, Bayside, NY (US)

(21) Appl. No.: 13/403,123

(22) Filed: Feb. 23, 2012

(51) Int. Cl. G02C 11/04

(52) U.S. Cl. 351/158

(57) ABSTRACT

A pair of glasses having LED illumination has a bridge, two temples, at least one cover and at least one LED controller. Each one of the at least one LED controller is mounted between a corresponding cover and a corresponding temple, and has a switch mounted on and protruding from an outside of a corresponding cover. The switch is pressed to control an LED bulb of the LED controller to emit light through a front end of the glasses. Each cover and a corresponding temple have multiple snap-fit type joints respectively formed thereon. Each temple has retaining protrusions to hold a corresponding LED controller. Accordingly, assembling and fixing the present invention requires no bolts. The present invention is advantageous in easy assembly, convenient replacement of battery, intuitive operation and more safety protection.

### BACKGROUND OF THE INVENTION

1. Field of the Invention

The present invention relates to a pair of glasses, and more particularly to a pair of glasses having light-emitting diode (LED) illumination.

2. Description of the Related Art

To facilitate reading in insufficiently illuminated places, such as in the airplane, train, bed and the like, and to facilitate safe walking in the nighttime or repairing things and reorganizing goods, such as vehicle services, reorganization of storage cabinet and the like, in a confined space, small additional lighting apparatuses emerge in that regard. One type of small additional lighting apparatuses pertains to glasses having LED illumination. With reference to FIG. 5, a pair of conventional glasses having LED illumination has a bridge 70 and two temples 60. Each temple 60 has a receiving recess 61, an LED controller, a fixed cover 65 and a pivotable cover 66. The receiving recess 61 is formed in an inner side of the temple 60 and adjacent to the bridge 70. The LED controller is mounted inside the receiving recess 61 and has a circuit board. The circuit board has an LED bulb 62, a battery set 63 and a push button 64 mounted thereon. The LED bulb 62 is mounted through and protrudes beyond a front end of the temple 60. The battery set 63 is mounted inside the receiving recess 61. The fixed cover 65 is mounted on the inner side of the temple 60 with multiple bolts to cover the circuit board. The push button 64 is mounted through and protrudes beyond the fixed cover 65, and is pushed to turn on or off the LED bulb 62. The pivotable cover 66 is pivotally mounted on the temple 60 with a pivot 67 to cover the battery set 63 inside the receiving slot 61 and is pivoted upwardly to open the receiving recess 61 for replacement of the battery set 63.

However, the pair of conventional glasses has the shortcomings in terms of its structural design.

1. As the push buttons 64 are mounted on the inner sides of the respective temples 60, when turning on or off the LED bulbs 62, users must take off the glasses or use two fingers to press the push buttons 64 at the same time. When turning on or off the LED bulbs 62 in a filthy environment, users' fingers easily touch users' faces or eyes. Such operation runs counter to the principles of personal hygiene and simple and convenient operation, and fails to conform to the intuitive habit of ordinary consumers in operating the glasses having LED illumination.

2. As the fixed cover 65 and the pivotable cover 66 are all fixed by bolts, instrument or hand tool is required during assembling the pair of conventional glasses and the conventional glasses are produced with more labor and time and the production cost thereof is therefore higher.

3. To ensure the completeness and aesthetic consideration in terms of the appearance of the conventional glasses, the LED controller is mounted on the inner side of each temple 60. However, the fixed covers 65 and the pivotable covers 66 are mounted on the temples 60 with bolts. Those bolts that are visible from the inner side of the temples 60 are indeed aesthetically unpleasant and conflict with the sense of quality pursued by modernized people.

4. As ten bolts are used to fasten the fixed covers 65 on the inner sides of the temples 60, those bolts need to be electroplated or treated against rusting, making them against concepts of environmental protection.

5. As the battery sets 63, the push buttons 64 and the fixed covers 65 are separable parts, they may cause a safety concern of possibly jeopardizing human body, such as the eyes or face, when they inadvertently come off due to collision or improper assembly of the conventional glasses.

### SUMMARY OF THE INVENTION

An objective of the present invention is to provide a pair of glasses having LED illumination facilitating assembly and operation and enhancing aesthetic appearance, practicability in everyday life and safety protection.

To achieve the foregoing objective, the pair of glasses having LED illumination has two temples, at least one LED controller and at least one cover.

Each one of at least one of the temples has a receiving recess and a through hole. The receiving recess is formed in an outside of a front end of the temple. The through hole is formed through a front end of the temple to communicate with the receiving recess.

Each one of the at least one LED controller has a circuit board, an LED bulb, a battery set and a switch. The LED bulb is mounted on the circuit board and is adjacent to the through hole of a corresponding temple.

The battery set is mounted on the circuit board.

The switch is mounted on the circuit board.

Each one of the at least one cover is mounted on an outside of a front portion of one of the temples to cover a corresponding receiving recess and has a switch hole and a touch guiding wall.

The switch hole is formed through the cover for the switch of a corresponding LED controller to be mounted through the switch hole and has a bore perimeter.

The touch guiding wall is axially formed around and protrudes outwardly from the bore perimeter of the switch hole.

Preferably, the touch guiding wall of a corresponding cover is formed on a top edge of the switch hole of the cover.

Preferably, each one of the at least one switch has a switch cap mounted around one end of the switch and mounted through the switch hole of a corresponding cover.

Preferably, the pair of glasses further comprises multiple snap-fit type joints respectively formed on a corresponding cover and a corresponding receiving recess.

Preferably, each snap-fit type joint has a groove and multiple barbed legs. The groove is formed in an inner wall of a corresponding receiving recess facing the through hole of a corresponding temple. Each barbed leg is formed on an inner wall of a corresponding cover, protrudes toward a corresponding receiving recess, and is snap-fitted in the groove.

Preferably, each one of the at least one cover further has a thumb piece formed on and protruding outwardly from an outer wall of the cover and serving for opening a corresponding cover.

Preferably, each one of the at least one receiving recess further has multiple position limiting ribs formed on an inner wall of the receiving recess, protruding toward a corresponding cover, and mounted around a corresponding LED controller, and each one of the at least one cover further has multiple retaining protrusions formed on and protruding from an inner wall of the cover facing the inner wall of a corresponding receiving recess, and mounted around the corresponding LED controller.

Preferably, each one of at least one of the temples further has a reflective surface obliquely formed in the front end wall of the receiving recess and formed around and extending radially and outwardly from the through hole of the temple.

Preferably, the reflective surface of each one of at least one of the temples is coated with a reflective material.

The implementation of the pair of glasses having LED illumination secures the following advantages.

1. As each of the at least one switch is mounted on the outside of a corresponding temple, intuitive operation and personal hygiene can be easily fulfilled when a user wears the pair of glasses and operates the switch.

2. All movable parts are mounted on the outside of at least one of the temples, thereby ensuring the safety protection to human body.

3. As the touch guiding wall is axially formed around and protrudes outwardly from a bore perimeter of the switch hole, unnecessary power loss arising from inadvertent touch of a corresponding switch can be avoided.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pair of glasses having LED illumination in accordance with the present invention;

FIG. 2 is an enlarged exploded perspective view of the pair of glasses in FIG. 1;

FIG. 3 is an enlarged front view in partial section of the pair of glasses in FIG. 1;

FIG. 4 is an enlarged top view in partial section of the pair of glasses in FIG. 1; and

FIG. 5 is a partial perspective view of a pair of conventional glasses having LED illumination.

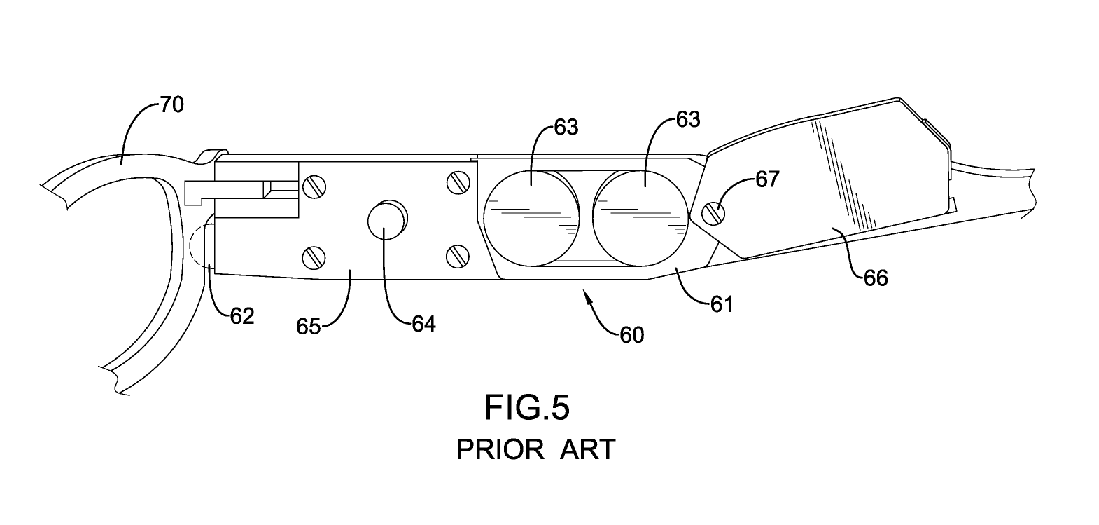

### DETAILED DESCRIPTION OF THE INVENTION

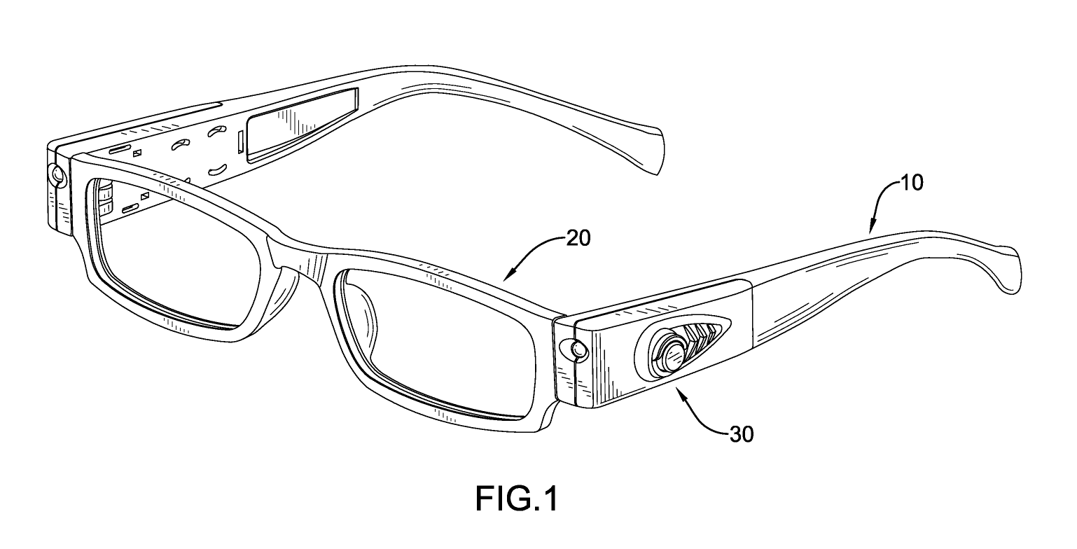

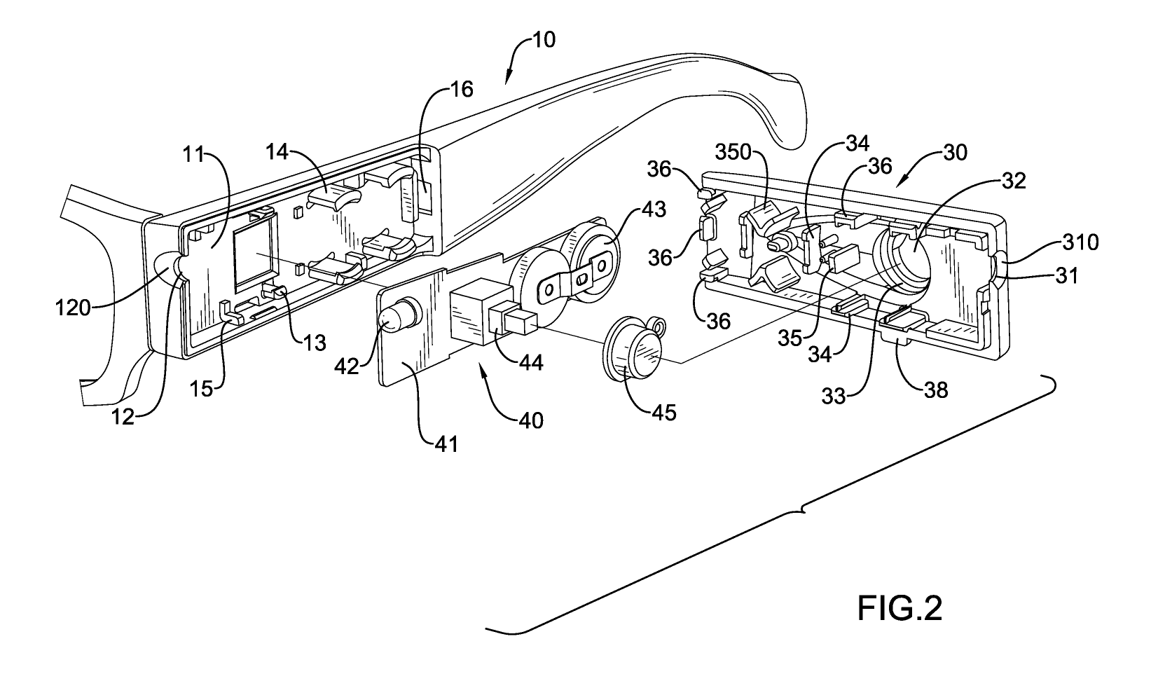

With reference to FIGS. 1 and 2, a pair of glasses having LED illumination in accordance with the present invention has two temples 10, a bridge 20, at least one cover 30 and at least one LED controller 40. Each one of at least one of the temples 10 has a receiving recess 11 formed in an outside of a front end of the temple 10. The bridge 20 is mounted between the two front ends of the two temples 10. Each one of the at least one cover 30 is mounted on an outside of a front portion of one of the temples 10 to cover a corresponding receiving recess 11 and has an arc-shaped opening 31 formed through a front end wall of the cover 30. Each one of the at least one LED controller 40 is mounted between a corresponding cover 30 and a corresponding temple 10, and has a circuit board 41, an LED bulb 42, a battery set 43 and a switch 44 mounted on the circuit board 41. Preferably, the switch 44 is a mechanical push button, which must be operated manually to switch on or off and therefore gets rid of the power loss issue arising from a normally switching-on state of an electronic switch (mechanical and electronic switches pertain to a common technique and are not further described here), and has a switch cap 45 mounted around one end of the push button.

Each one of the at least one LED controller 40 is mounted inside a corresponding receiving recess 11. Each one of the at least one receiving recess 11 has an arc-shaped opening 12 formed through a front end wall of the receiving recess 11, and corresponding to the arc-shaped opening of a corresponding cover 30. The arc-shaped opening 12 of one of the at least one receiving recess 11 and the arc-shaped opening 31 of a corresponding cover 30 are joined together to form a through hole adjacent to the LED bulb 42 for the LED bulb 42 to emit light through the through hole. Preferably, a reflective surface 120, 310 is obliquely formed in the front end wall of the receiving recess 11, and is formed around and extends radially and outwardly from the through hole of a corresponding temple 10 so that light emitted from the LED bulb 42 can be further reflected by the reflective surfaces to enhance illumination. The reflective surfaces 120, 310 can be coated with reflective material, such as chromium plating, silver paint and the like, to further increase lighting effect.

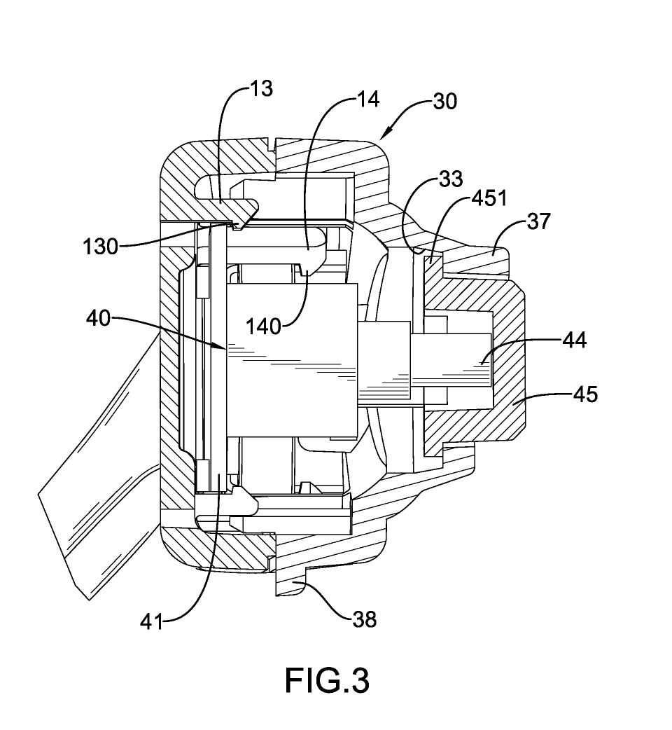

With reference to FIGS. 2 and 3, each one of the at least one receiving recess 11 has multiple position limiting ribs 13, 14, 15 formed on an inner wall of the receiving recess 11 and protruding toward a corresponding cover 30 to hold the circuit board 41 within the position limiting ribs 13, 14, 15. Part of the position limiting ribs 13, 14 have hooks 130, 140 formed on free ends thereof and protruding toward a corresponding circuit board 41 to prevent the LED controller 40 from coming off.

Each one of the at least one cover 30 has a switch hole 32 formed through the cover 30 for the switch 44 and the switch cap 45 to be mounted therethrough. In the present embodiment, in response to the design of the push button, each one of the at least one cover 30 further has an annular recess 33 and a touch guiding wall 37. The annular recess 33 is radially formed in an inner wall of the switch hole 32. The switch cap 45 of each of the at least one switch 44 has a bottom flange 451 formed on and radially protruding from a bottom of the switch cap 45, and abutting against and blocked by the annular recess 33 of a corresponding cover 30. The touch guiding wall 37 is axially formed around and protrudes outwardly from a bore perimeter of the switch hole 32 to avoid unnecessary power loss arising from inadvertent touch of a corresponding switch 44. Preferably, the touch guiding wall 37 is formed on a top edge of the switch hole 32 so that it is convenient for users' fingers to access and press the switch 44 from below the touch guiding wall 37 when users are wearing the pair of glasses.

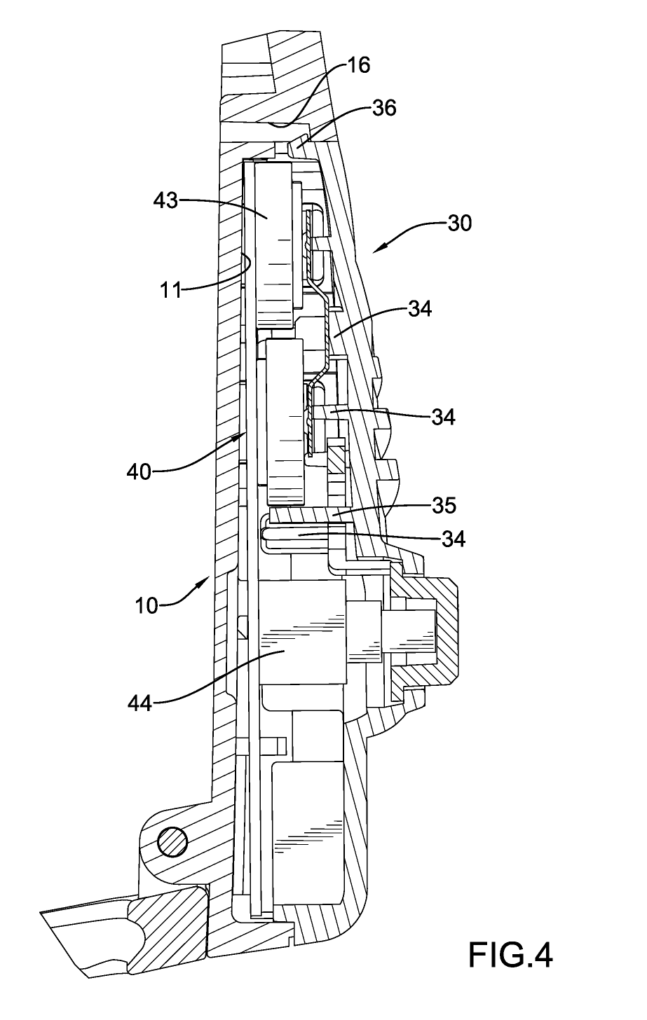

With reference to FIGS. 2 and 4, each one of the at least one cover 30 further has multiple retaining protrusions 34 and multiple blocking protrusions 35, 350 formed on and protruding from an inner wall of the cover 30 corresponding to the inner wall of a corresponding receiving recess 11, and having shapes matching surfaces and positions of a corresponding circuit board 41 and a corresponding battery set 43, so that a corresponding LED controller 40 can be firmly mounted inside the corresponding receiving recess 11. Each one of the at least one cover 30 further has multiple barbed legs 36. Each barbed leg 36 is formed on the inner wall of the cover 30, and protrudes toward a corresponding receiving recess 11. The receiving recess 11 has a groove 16 formed in an inner wall facing the through hole. The barbed legs 36 are snap-fitted in the groove 16. Alternatively, the barbed legs 36 and the groove 16 can be formed on the receiving recess 11 and the cover 30. Accordingly, no bolts are required to fasten the covers 30 on the respective temples 10.

To facilitate opening of each one of the at least one cover 30 for replacement of a corresponding battery set 43, the cover 30 further has a thumb piece 38 formed on and protruding outwardly from an outer wall of the cover 30. In the present embodiment, each thumb piece 38 is formed on and protrudes from a bottom portion of a corresponding cover 30, and the barbed legs 36 are formed on a top portion and a rear portion of the cover 30 so that the barbed legs 36 disengage from the groove 16 when the thumb piece 38 is thrust outwardly by a force to remove the cover 30.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pair of glasses having light-emitting diode (LED) illumination, comprising:
two temples, wherein each one of at least one of the temples has:
a receiving recess formed in an outside of a front end of the temple; and
a through hole formed through a front end of the temple to communicate with the receiving recess;
at least one LED controller mounted respectively in the receiving recess of at least one of the temples, each one of the at least one LED controller having:
a circuit board;
an LED bulb mounted on the circuit board and being adjacent to the through hole of a corresponding temple;
a battery set mounted on the circuit board; and
a switch mounted on the circuit board; and
at least one cover, each one of the at least one cover mounted on an outside of a front portion of one of the temples to cover a corresponding receiving recess and having:
a switch hole formed through the cover for the switch of a corresponding LED controller to be mounted through the switch hole and having a bore perimeter; and
a touch guiding wall axially formed around and protruding outwardly from the bore perimeter of the switch hole.

2. The pair of glasses as claimed in claim 1, wherein the touch guiding wall of a corresponding cover is formed on a top edge of the switch hole of the cover.

3. The pair of glasses as claimed in claim 2, wherein each one of the at least one switch has a switch cap mounted around one end of the switch and mounted through the switch hole of a corresponding cover.

4. The pair of glasses as claimed in claim 1, further comprising multiple snap-fit type joints respectively formed on a corresponding cover and a corresponding receiving recess.

5. The pair of glasses as claimed in claim 2, further comprising multiple snap-fit type joints respectively formed on a corresponding cover and a corresponding receiving recess.

6. The pair of glasses as claimed in claim 3, further comprising multiple snap-fit type joints respectively formed on a corresponding cover and a corresponding receiving recess.

7. The pair of glasses as claimed in claim 4, wherein each snap-fit type joint has:
a groove formed in an inner wall of a corresponding receiving recess facing the through hole of a corresponding temple; and
multiple barbed legs, each barbed leg formed on an inner wall of a corresponding cover, protruding toward a corresponding receiving recess, and snap-fitted in the groove.

8. The pair of glasses as claimed in claim 5, wherein each snap-fit type joint has:
a groove formed in an inner wall of a corresponding receiving recess facing the through hole of a corresponding temple; and
multiple barbed legs, each barbed leg formed on an inner wall of a corresponding cover, protruding toward a corresponding receiving recess, and snap-fitted in the groove.

9. The pair of glasses as claimed in claim 6, wherein each snap-fit type joint has:
a groove formed in an inner wall of a corresponding receiving recess facing the through hole of a corresponding temple; and
multiple barbed legs, each barbed leg formed on an inner wall of a corresponding cover, protruding toward a corresponding receiving recess, and snap-fitted in the groove.

10. The pair of glasses as claimed in claim 4, wherein each one of the at least one cover further has a thumb piece formed on and protruding outwardly from an outer wall of the cover, and serving for opening the cover.

11. The pair of glasses as claimed in claim 5, wherein each one of the at least one cover further has a thumb piece formed on and protruding outwardly from an outer wall of the cover for opening a corresponding cover.

12. The pair of glasses as claimed in claim 6, wherein each one of the at least one cover further has a thumb piece formed on and protruding outwardly from an outer wall of the cover, and serving for opening a corresponding cover.

13. The pair of glasses as claimed in claim 1, wherein
each one of the at least one receiving recess further has multiple position limiting ribs formed on an inner wall of the receiving recess, protruding toward a corresponding cover, and mounted around a corresponding LED controller; and
each one of the at least one cover further has multiple retaining protrusions formed on and protruding from an inner wall of the cover facing the inner wall of a corresponding receiving recess, and mounted around the corresponding LED controller.

14. The pair of glasses as claimed in claim 4, wherein
each one of the at least one receiving recess further has multiple position limiting ribs formed on an inner wall of the receiving recess, protruding toward a corresponding cover, and mounted around a corresponding LED controller; and
each one of the at least one cover further has multiple retaining protrusions formed on and protruding from an inner wall of the cover facing the inner wall of a corresponding receiving recess, and mounted around the corresponding LED controller.

15. The pair of glasses as claimed in claim 5, wherein
each one of the at least one receiving recess further has multiple position limiting ribs formed on an inner wall of the receiving recess, protruding toward a corresponding cover, and mounted around a corresponding LED controller; and
each one of the at least one cover further has multiple retaining protrusions formed on and protruding from an inner wall of the cover facing the inner wall of a corresponding receiving recess, and mounted around the corresponding LED controller.

16. The pair of glasses as claimed in claim 6, wherein
each one of the at least one receiving recess further has multiple position limiting ribs formed on an inner wall of the receiving recess, protruding toward a corresponding cover, and mounted around a corresponding LED controller; and
each one of the at least one cover further has multiple retaining protrusions formed on and protruding from an inner wall of the cover facing the inner wall of a corresponding receiving recess, and mounted around the corresponding LED controller.

17. The pair of glasses as claimed in claim 1, wherein each one of at least one of the temples further has a reflective surface obliquely formed in the front end wall of the receiving recess and formed around and extending radially and outwardly from the through hole of the temple.

18. The pair of glasses as claimed in claim 1, wherein the reflective surface of each one of at least one of the temples is coated with a reflective material.
